(19) United States
(12) Patent Application Publication
(10) Pub. No.: US 2024/0416879 A1
(43) Pub. Date: Dec. 19, 2024

(54) ADAPTIVELY ADJUSTED AND ACCURATE PARKING CONTROL METHOD FOR ATO SYSTEM

(71) Applicant: CASCO SIGNAL LTD., Jing'an District, Shanghai (CN)

(72) Inventors: Lizhong GU, Jing'an District, Shanghai (CN); Xinjun LV, Jing'an District, Shanghai (CN); Weiyang WANG, Jing'an District, Shanghai (CN); Bo XIONG, Jing'an District, Shanghai (CN); Jiahua SONG, Jing'an District, Shanghai (CN); Jun WANG, Jing'an District, Shanghai (CN)

(21) Appl. No.: 18/708,931

(22) PCT Filed: Nov. 11, 2022
(86) PCT No.: PCT/CN2022/130912

§ 371 Date: May 9, 2024

(30) Foreign Application Priority Data
Aug. 8, 2022 (CN) 202210943538.0

(51) Int. Cl. B60T 8/32; B61L 15/00

(52) U.S. Cl. CPC B60T 8/32; B61L 15/0058; B61L 15/0062

(57) ABSTRACT

An adaptively adjusted and accurate parking control method for an ATO system includes performing statistical learning on the basis of historical stop information, and adaptively inferring a parking point offset. Moreover, two application preconditions of the method are provided: firstly, speed tracking performance is good in an electric braking stage, and secondly, a pneumatic braking process has random and statistical stationary characteristics. The method improves the average stop accuracy in a statistical sense, satisfies a high-accuracy stop requirement of the entire train formation, and can also evaluate train performances and track circumstances timely and duly, thereby satisfying complex and variable real-time operation task requirements.

### TECHNICAL FIELD

The present invention relates to the field of urban rail transit, specifically to an adaptively adjusted and accurate parking control method for an ATO system.

### BACKGROUND

The urban rail transit line has the characteristics of short inter-station distance and high traffic density. The reliability and efficiency of a train automatic driving system have a great impact on the line operation capability. With the rapid development of urban rail transit technologies, many newly built lines have opened up full-automatic unmanned operations, and are equipped with forward and reverse automatic jog functions. Although the automatic jog can control the train to run at low speed for a short distance so as to realize the accurate docking again in the case of inaccurate parking, during the peak operation period of a busy line, the inaccurate docking of the train automatic train operation (ATO) system to the station for the first time will seriously affect the operation efficiency of the line.

The typical reason for the inaccurate docking in the train ATO mode is mismatched compound control of electric braking and pneumatic braking in the low-speed stage, such as early fading out of electric braking and failure to timely supplement pneumatic braking, resulting in a decrease in the braking force of the entire train and an over docking tendency. Compared with pneumatic braking, electrical braking has a characteristic of low latency and quick response, and has a high control precision and fine linearity. In order to prolong the action time of electric braking in a low-speed parking phase and reduce the action time of pneumatic braking, the Train Control and Management System (TCMS) adopts a on-line calculation method for the speed point at which the electric braking begins to fade out, which lowers the speed point at which the electric braking completely fades out. In this way, even if the pneumatic braking is attenuate, the accuracy error range of ATO parking can be guaranteed with a high probability.

The pneumatic braking system is composed of air supply and mechanical braking devices, and is easily affected by the working environment, so that the stop accuracy distribution of the train ATO has a random characteristic. In addition, considering the entire train formation, there are objective differences in performance between different trains, it is difficult to achieve high-accuracy control of all trains within the formation through the same version of ATO parameters. The stopping accuracy of each train will always vary to some extent, and it is difficult to simultaneously meet the high-accuracy requirement for the first stopping on high traffic density operation lines. With the increase of operation mileage and service life, the braking device of the train will also experience a certain degree of wear and aging, and the possibility of performance parameter drift of the train is relatively high. The above objective factors pose great challenges to high-accuracy parking control of the ATO system. Fixed parameters of the ATO system are not easy to adapt to changes in track environment and train performance, making it difficult to achieve high-accuracy parking control.

### SUMMARY

The object of the present invention is to provide an accurate parking control method for an ATO system, which enables the system to adapt to changes in track environment and train performances, so that the system always operates in an optimal working condition and satisfies high-accuracy parking requirements of an entire train formation.

In order to achieve the above object, the present invention provides an adaptively adjusted and accurate parking control method for an ATO system, including the following steps:
S1, monitoring a speed tracking performance of a train during each stop process, and determining whether each stop process of the train satisfies an acceptable stop statistical condition;
S2, updating the result of a stop process satisfying the acceptable stop statistical condition to a stop array queue, and using n stops as a learning period to calculate a statistical feature of every n stop results;
S3, adaptively calculating a parking point offset according to the calculated statistical feature of every n stop results in S2; and
S4, evaluating, on the basis of the above steps, the every stop result of the train and the stop results within each learning period, and if a set threshold is exceeded, then clearing the existing parking point offset and restarting a new round of learning process.

Preferably, the acceptable stop statistical condition comprises: good speed tracking performance in an electric braking process during the train stop stage, no interference during the train stop stage, and a train stop accuracy satisfying a preset threshold.

Preferably, a determination standard of the good speed tracking performance in an electric braking process during the train stop stage is: a reference speed in the electric braking process of the train is set as a target speed; a difference between the target speed and an actual train speed is defined as a speed deviation; and if the speed deviation satisfies a preset threshold, or if the speed deviation exceeds a preset threshold but the speed tracking process converges, then the speed tracking performance in the electric braking process during the train stop stage is considered to be good.

Preferably, interference factors during the train stop stage comprise: non-master core control, non-ATO train control, and platform stopping by taking a non-parking point as the strongest constraint.

Preferably, the acceptable stop statistic condition is also applied to a train real-time stop process; and when a certain train real-time stop process does not satisfy the acceptable stop statistic condition, the stop does not use the method.

Preferably, the stop array queue is SSP_Accuracy_Array, and the statistical feature of every n stop results comprises a median offset Offset_Median, a mean offset Offset_Mean and a standard deviation offset Offset_Std.

Preferably, a calculation formula of the parking point offset SSP_Offset_Adjust is:

SSP_Offset_Adjust+=Adjust_Delta; wherein, Adjust_Delta is a correction increment of a learning period, the sign+=represents an accumulation operation, and the above formula represents accumulating the correction increment Adjust_Delta of the current learning period on the basis of the last learning period.

Preferably, a calculation formula of the correction increment Adjust_Delta is as follows:

$${Adjust}_{Delta} = \{ \begin{matrix}{QUICK}_{STEP} \times SIGN ( \cdot ) , & In {QUICK}_{REGION} \\ {FINE}_{STEP} \times SIGN ( \cdot ) , & In {FINE}_{REGION} \\ 0 , & Otherwise\end{matrix} ;$$

wherein QUICK_REGION is a preset fast adjustment region, and QUICK_STEP represents a fast adjustment step length adopted when Offset_Median is in the fast adjustment region QUICK_REGION; FINE_REGION is a preset fine adjustment region, and FINE_STEP represents a fine adjustment step length adopted when Offset_Median is within the fine adjustment region FINE_REGION; SIGN(⋅) is a sign operation function which returns ±1 according to the positivity and negativity of Offset_Median.

Preferably, the parking point offset SSP_Offset_Adjust is constrained with limit values: an upper adjustment limit value and a lower adjustment limit value are set; when a parking point offset SSP_Offset_Adjust acquired after a learning period is greater than the upper adjustment limit value, then the upper adjustment limit value is taken as the parking point offset of the train in the next learning period; and when the parking point offset SSP_Offset_Adjust acquired after a learning period is less than the lower adjustment limit value, then the lower adjustment limit value is taken as the parking point offset of the train in the next learning period.

Preferably, step S4 comprises the following two cases:
S41, instantly evaluating a single stop result of the train, and if a train stop characteristic abruptly changes, then clearing the existing parking point offset SSP_Offset_Adjust, and immediately restarting a new round of learning process; and
S42, statistically evaluating the stop results of the train in each learning period, and if the n stop results of the train in the learning period do not satisfy a statistical stationary characteristic, then clearing the existing parking point offset SSP_Offset_Adjust, and restarting a new round of learning process.

Preferably, the definition for abrupt changes of train stop characteristic is: a certain stop accuracy of a train having an under-docking characteristic exceeds a preset allowable over-docking distance, or a certain stop accuracy of a train having an over-docking characteristic exceeds a preset allowable under-docking distance.

Preferably, the train having an under-docking characteristic means that the existing parking point offset SSP_Offset_Adjust is greater than zero; and the train having an over-docking characteristic means that the existing parking point offset SSP_Offset_Adjust is less than zero.

Preferably, the conditions for determining whether the train stop satisfies the statistical stationary characteristic are as follows: a difference between the mean offset Offset_Mean and the median offset Offset_Median does not exceed a preset deviation threshold, and the standard deviation offset Offset_Std does not exceed a preset convergence trend threshold.

Preferably, when the number of restarting a learning process due to the abrupt change of the train stop characteristic in a single instant evaluation of the train exceeds a preset abrupt change number threshold, then the learning process is not restarted subsequently, and the present method is no longer used to control parking; meanwhile, when the number of restarting a learning process due to the reason that the train stop does not satisfy the statistical stationary characteristic during statistical train evaluation exceeds a preset non-stationary number threshold, then the learning process is not restarted subsequently, and the present method is no longer used to control parking.

In conclusion, the present method includes, on the basis of historical stop information, performing statistical learning and adaptively inferring a stop point offset, and has the following advantages.

1. In the present invention, statistical inference is performed on the basis of historical stop information, thereby reducing interference of pneumatic braking randomness on train stop accuracy, and improving average stop accuracy in a statistical sense;

2. In the present invention, a step length can be adaptively adjusted according to a stop statistical result, and a stop point offset can be learned, thereby achieving a high-accuracy parking requirement of an entire train formation;

3. In the present invention, the speed tracking performance is monitored in the electric braking process, a single stop is instantly evaluated, and multiple stops is statistically evaluated, so that train performances and track circumstances can be evaluated timely and duly, and a learning process can be restarted or exited, thereby satisfying complex and variable real-time operation task requirements.

### BRIEF DESCRIPTION OF DRAWINGS

FIG. 1 is a schematic view of three braking processes involved in a train stop stage;

FIG. 2 is a schematic diagram of the comparison between graphical curves of the train correct docking and over-docking;

FIG. 3 is a functional block diagram of adaptively adjusted stop of a train ATO system in the present invention;

FIG. 4 is a schematic diagram of monitoring a speed tracking performance in an electric braking stage of a train in an embodiment of the present invention;

FIG. 5 is a schematic diagram of updating the stop array queue of a train in an embodiment of the present invention;

FIG. 6 is a schematic diagram of re-learning in a scenario of abrupt changes of a train stop characteristic in an embodiment of the present invention; and

FIG. 7 is a schematic diagram of monitoring and evaluating a train interstation running process in an embodiment of the present invention.

### DESCRIPTION OF EMBODIMENTS

The technical solutions, structural features, objectives and effects achieved in the embodiments of the present invention are described in detail in the following with reference to the accompanying drawings in the embodiments of the present invention.

It should be noted that, the accompanying drawings are in a very simplified form and all use inaccurate proportions, are merely used for conveniently and clearly illustrating the objectives of the embodiments of the present invention and are not intended to be limited to the specific conditions for carrying out the present invention, and thus does not have a technical significance. Any modification of the structure, change of the proportional relations or adjustment of the size shall belong to the scope covered by the technical contents disclosed in the present invention, without affecting the efficacy produced and the objectives achieved by the present invention.

It should be noted that, in the present invention, relational terms such as first and second are only used to distinguish one entity or operation from another entity or operation, and do not necessarily require or imply any actual relationship or sequence between these entities or operations. Furthermore, the terms “comprise”, “include”, or any other variant thereof are intended to cover a non-exclusive inclusion, so that a process, a method, an article, or a device that includes a series of elements not only includes elements that are explicitly listed, but also includes other elements that are not explicitly listed, or further includes elements inherent to the process, the method, the article, or the device.

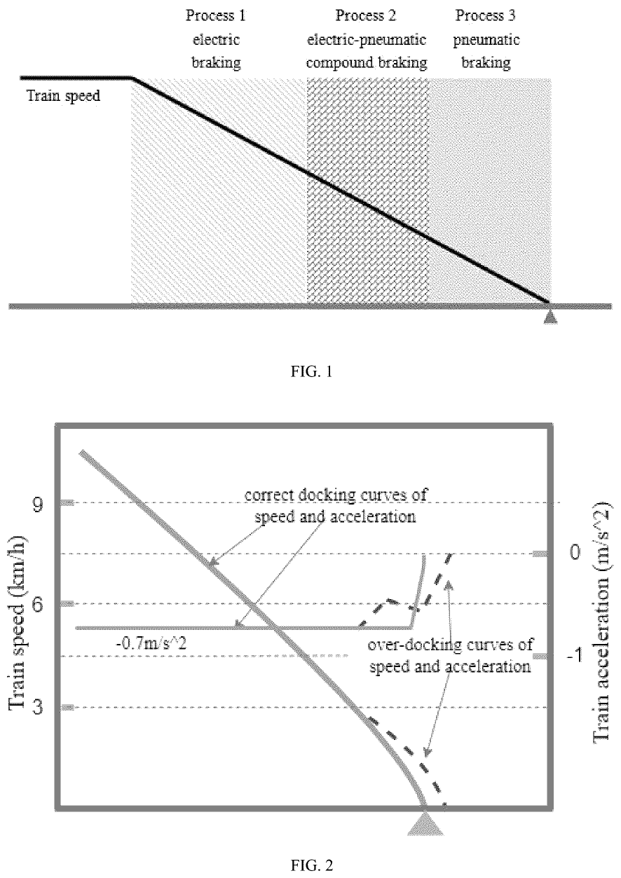

The common stop stage of an urban rail transit train is analyzed. As shown in FIG. 1, the stop stage of an urban rail transit train generally comprises three braking processes: an electric braking process, a compound electric-pneumatic braking process, and a pneumatic braking process. Due to factors such as brake shoe wear, the linearity of an pneumatic braking process tracking a signal command is not as good as that of an electric braking process. In addition, in a low-speed stage of the compound electric-pneumatic braking process, the descending slope of the electric braking process is not always consistent with the ascending slope of the pneumatic braking process, such that the braking force of the whole train changes non-linearly. All the above factors result in a certain degree of randomness in each stop of the train. However, according to the statistical distribution evaluation of multiple stop results, train stops may exhibit a certain trend, for example, some trains have a over-docking tendency.

FIG. 2 is a schematic comparison diagram of speed and acceleration curves of two stop processes (correct docking and over-docking) of a train. The graph curves of the two stop processes at a speed greater than 3 kph almost completely coincide with each other. When the speed of the train decreases below 3 kph, the speed curves and acceleration curves of the two stop processes are separated due to randomness of pneumatic braking, thereby causing a stop error. If the speed is below 3 kph when the speed curve shows separation, as long as the pneumatic braking attenuation does not exceed 30%, the parking accuracy range can still be ensured to be no more than 30 cm, however, it does not satisfy the requirement of high-accuracy parking. Further analysis shows that at the moment when speed curves separate, the train is about 0.4 meters away from the parking point, and the remaining time is only about 0.8 seconds. Considering that the pneumatic braking has a relatively large delay, there is almost no time left for the ATO to perform effective train control adjustment. The ATO can only suppress the over-docking trend of the train, and therefore it is difficult to achieve a high-accuracy parking control objective solely on the basis of the current moment information such as the speed error.

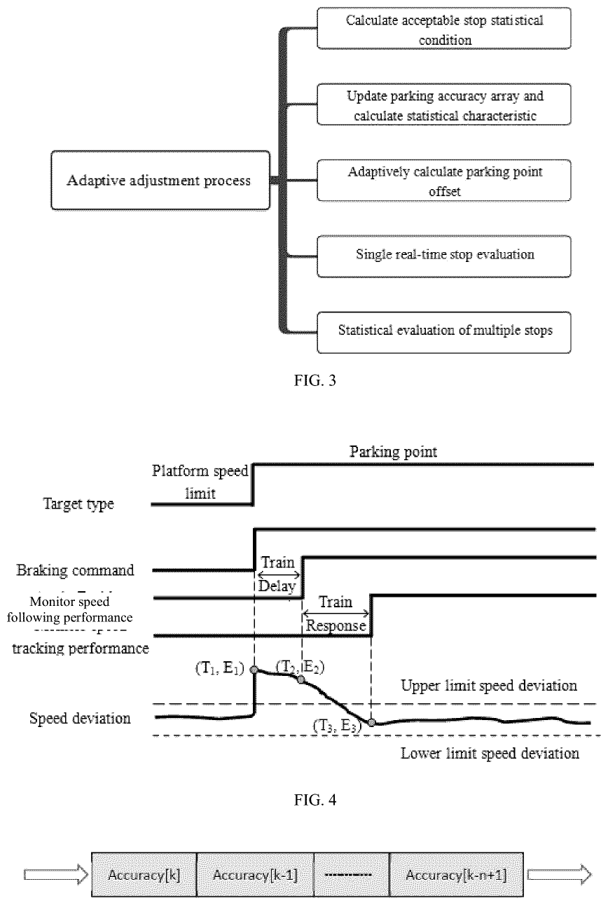

On the basis of the described problem, considering that there are some trends in train stop, in order to improve the first stop accuracy of a train and reduce the influence of pneumatic braking randomness interference, the present invention provides an adaptively adjusted and accurate parking control method for an ATO system, as shown in FIG. 3, including the following steps:

S1, monitoring a speed tracking performance of a train during each stop process, and determining whether a stop process of the train satisfies an acceptable stop statistical condition;

In order to perform statistical inference on the basis of historical stop information and then apply the statistical inference to a future stop process, a certain degree of similarity is required for each stop process of the train. However, in order to ensure the similarity of each stop process of the train, it is necessary to determine whether a stop process of the train satisfies an acceptable stop statistical condition, and the acceptable stop statistical condition comprises the following aspects:

S11, good speed tracking performance in an electric braking process during the train stop stage;

The electric braking process during the train stop stage starts from the time when the train enters the platform region to the time when the electric braking of the electric-pneumatic compound braking process starts to fade out. Even if the subsequent electric-pneumatic compound braking process does not cooperate ideally, the good speed tracking performance in the electric braking process can still ensure the final parking accuracy error range. Therefore, the train stop process which can be brought into stop statistical inference needs to meet the condition of good speed tracking performance in an electric braking process during the train stop stage.

A reference speed in the electric braking process of the train is set as a target speed; a difference between the target speed and an actual train speed is defined as a speed deviation; a determination standard of the good speed tracking performance in an electric braking process is as follows: the speed deviation satisfies a preset threshold, or the speed deviation exceeds a preset threshold but the speed tracking process converges. The preset threshold for the speed deviation can be set according to actual needs.

FIG. 4 shows a schematic diagram of monitoring a speed tracking performance in an electric braking process in a stop stage of the train. When entering a platform region, the train enters a parking braking state from a cruising state. The system sends a signal of a braking command at time T1. After a period of time delay, the braking command is actually applied to the train at time T2. After a period of braking response time, the train makes a braking response at time T3 and enters a steady state. Although the speed deviations within the train braking response time period do not all satisfy the preset threshold range, the speed deviation E3 at time T3 is less than the speed deviation E2 at time T2, which indicates that the speed tracking process converges. Therefore, the speed tracking performance is good within the period T2 to T3. During the subsequent electric braking period, the speed deviation is within the preset threshold range, which indicates that the speed tracking performance during the train stop stage is good.

S12, no interference during the train stop stage;

Interference factors during the train stop stage comprise: non-master core control, non-ATO train control, and platform stopping by taking a non-parking point as the strongest constraint. If the described interference factors exist during the train stop stage, the train stop process does not satisfy the acceptable stop statistic condition, and thus the stop result of the train stop process is not accepted in the stop statistical inference.

S13, a train stop accuracy satisfying a preset threshold.

The acceptable stop statistic condition also includes that the stop accuracy after a train stops steadily should satisfy a preset threshold requirement. Generally, the preset threshold of the stop accuracy is ±0.5 m.

The above acceptable stop statistic condition is not only used to determine the availability of stop results, but also applied to the instant stop process of the train. For example, if there is a speed tracking problem or interference in a certain stop process, which does not satisfy the acceptable stop statistic condition, then the stop result is not accepted in the stop statistical inference, and the method of the present invention is also not be used for this stop, thereby preventing the stop accuracy from being poorer.

S2, updating the result of a stop process satisfying the acceptable stop statistical condition to a stop array queue, and using n stops as a learning period to calculate a statistical feature of every n stop results;

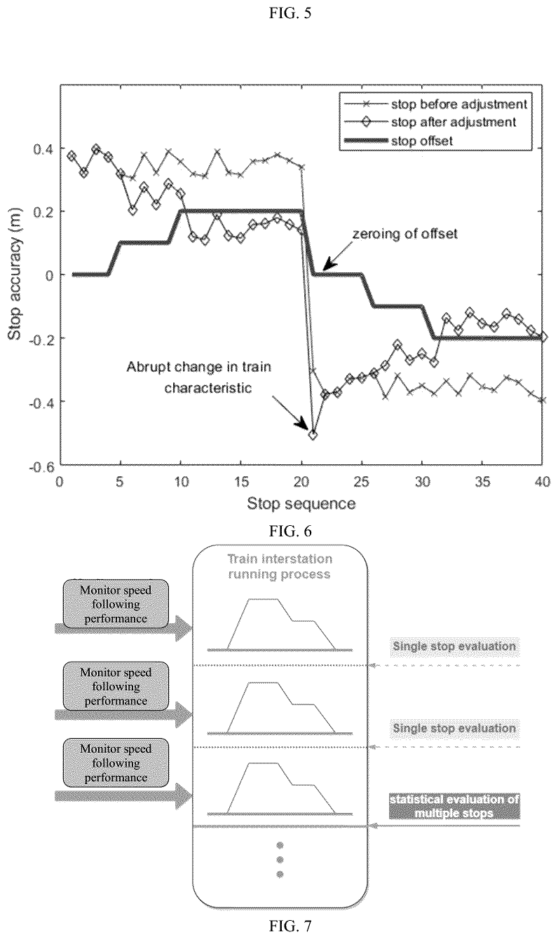

Specifically, after the train stops steadily at the platform, if the stop process of the train satisfies the acceptable stop statistical condition, then the stop result will be updated to a stop array queue SSP_Accuracy_Array. As shown in FIG. 5, the stop array SSP_Accuracy_Array stores n stop results, and first-in-first-out. Every n stop is used as a learning period to calculate a statistical feature of every n stop results, i.e., calculating a median offset, a mean offset and a standard deviation offset of every n stop results, the calculation formula thereof is as follows:
Offset_Median=median (SSP_Accuracy_Array)
Offset_Mean=mean (SSP_Accuracy_Array)
Offset_Std=std (SSP_Accuracy_Array)
wherein median, mean, std respectively represent performing median operation, mean operation and standard deviation operation on the stop array SSP_Accuracy_Array; Offset_Median represents a median offset of n stop results, Offset_Mean represents a mean offset of n stop results, and Offset_Std represents a standard deviation offset of n stop results.

S3, adaptively calculating a parking point offset SSP_Offset_Adjust according to the calculated statistical feature of n stops in S2; and

inferring a future stop result on the basis of historical stop information which belongs to inferring population information from local sample information; in order to avoid excessive adjustment possibly caused by a single-round learning and a slow learning process, setting two adjustment regions and corresponding adjustment step lengths, one being a quick adjustment region QUICK_REGION, and the other being a fine adjustment region FINE_REGION. That is, the median offset Offset_Median of n stops in this learning period is not directly taken as the parking point offset SSP_Offset_Adjust, and yet the corresponding step length will be taken according to which region range the median offset Offset_Median of n stops is located. Thus the expected parking point offset SSP_Offset_Adjust will be gradually approximated through multiple rounds of learning. The ranges of QUICK_REGION and FINE_REGION are set as needed for different trains.

Therefore, a correction increment Adjust_Delta is set, the correction increment Adjust_Delta of each learning period is calculated, and the correction increment Adjust_Delta of the latest learning period is accumulated to a parking point offset SSP_Offset_Adjust, so as to obtain a parking point offset SSP_Offset_Adjust for n subsequent train stops; after correction of multiple learning periods, gradual approximation is performed, and a train point offset SSP_Offset_Adjust is calculated.

According to the above, a calculation formula of the parking point offset SSP_Offset_Adjust is as follows:
SSP_Offset_Adjust+=Adjust_Delta
wherein the sign+=represents an accumulation operation, i.e., represents accumulating the correction increment Adjust_Delta of the current learning period on the basis of the last learning period.

The adaptive calculation formula of the correction increment Adjust_delta of each learning period is as follows:

$$Adjust\_Delta = \{ \begin{matrix}QUICK\_STEP \times SIGN ( \cdot ) , & In QUICK\_REGION \\ FINE\_STEP \times SIGN ( \cdot ) , & In FINE\_REGION \\ 0 , & Otherwise\end{matrix}$$

wherein QUICK_STEP represents a fast adjustment step length adopted when Offset_Median is in the fast adjustment region QUICK_REGION; FINE_STEP represents a fine adjustment step length adopted when Offset_Median is within the fine adjustment region FINE_REGION; SIGN(⋅) is a sign operation function which returns ±1 according to the positivity and negativity of Offset_Median.

It should be noted that adaptive adjustment of the parking offset is not used to solve the problem of stop error caused by poor speed tracking control during electric braking process, and is not intended to solve the problem of large range of errors in the stop accuracy caused by various interferences in the stop process. Instead, it is used for reducing the influence of the randomness of pneumatic braking on the stop accuracy, and belongs to micro-adjustment. Therefore, the parking point offset SSP_Offset_Adjust acquired in each round of learning is constrained with limit values: an upper adjustment limit value and a lower adjustment limit value are set; when a parking point offset SSP_Offset_Adjust acquired after a learning period is greater than the upper adjustment limit value, then the upper adjustment limit value is taken as the parking point offset for the next n stops of the train; and when the parking point offset SSP_Offset_Adjust acquired after a learning period is less than the lower adjustment limit value, then the lower adjustment limit value is taken as the parking point offset for the next n stops of the train.

S4, evaluating, on the basis of the above processes, the every stop result of the train and the stop results in each learning period, and if a preset threshold is exceeded, then clearing the existing parking point offset SSP_Offset_Adjust and restarting a new round of learning process. Specifically, the following two cases are included:

S41, instantly evaluating a single stop result of the train, and if a train stop characteristic abruptly changes, then clearing the existing parking point offset SSP_Offset_Adjust, and immediately restarting a new round of learning process; and

A train running on a track may encounter various possibilities, and needs to be evaluated in time according to each stop result. For example, when the track adhesion coefficient changes greatly due to factors such as weather, if the use of the historical stop information (i.e., arranging a train stop according to the stop point offset SSP_Offset_Adjust) results in a larger train stop error (which is expressed as an abrupt change in train stop characteristics), then a new round of learning process needs to be restarted, and the existing parking point offset SSP_Offset_Adjust is reset, otherwise, the train stop error will always continue for many times, it will not be corrected until after the n stop statistical evaluations.

The determination process of the abrupt change of the train stop characteristic is as follows: firstly, determining the train stop characteristic according to the positivity and negativity of the existing parking point offset SSP_Offset_Adjust, and providing: if the existing parking point offset SSP_Offset_Adjust is greater than zero, defining that the train has an under-docking stop characteristic; and if the existing parking point offset SSP_Offset_Adjust is less than zero, defining that the train has an over-docking stop characteristic. On the basis of the above provisions, the criteria for determining an abrupt change in a train stop characteristic are as follows: a certain stop accuracy of a train having an under-docking characteristic exceeds a preset allowable over-docking distance, or a certain stop accuracy of a train having an over-docking characteristic exceeds a preset allowable under-docking distance, and then an abrupt change in a train stop characteristic is defined. As shown in FIG. 6, the processes of zeroing and restarting learning of a parking point offset of a train in the case of an abrupt change in a parking characteristic are illustrated. The train originally has an under-docking parking characteristic. Due to factors such as track circumstance variation, the train stops exceeding a preset allowable over-docking distance; and an ATO determines that the train parking characteristic abruptly changes, and enters a new round of learning process in time.

When the stop characteristics of the train changes abruptly, the existing stop point offset SSP_Offset_Adjust needs to be cleared, and the n stop results satisfying the acceptable stop statistical condition are taken as the first learning period, and the stop point offset SSP_Offset_Adjust is recalculated.

S42, statistically evaluating the stop results of the train in each learning period, and if the n stop results of the train in the learning period do not satisfy a statistical stationary characteristic, then clearing the existing parking point offset SSP_Offset_Adjust, and restarting a new round of learning process;

The train uses every n stops as a learning period, and is also an evaluation period. In order to ensure statistical convergence of the stop accuracy of a train and avoid the phenomenon of a larger stop error caused by the application of historical stop information, it is necessary to perform statistical evaluation on every n stop results.

In particular, on the basis of the described three calculated stop statistical features: the median offset Offset_Median, the mean offset Offset_Mean and the standard deviation offset Offset_Std, it is determined whether the train stop result satisfies a stop statistical stationary characteristic of the train. The conditions for determining whether the train stop satisfies the statistical stationary characteristic are as follows: a difference between the mean offset Offset_Mean and the median offset Offset_Median does not exceed a preset deviation threshold, and the standard deviation offset Offset_Std does not exceed a preset convergence trend threshold. If n stop results of a certain learning period (i.e., an evaluation period) satisfy a determination condition for the train stop statistical stationary, executing S3, i.e., accumulating this correction increment Adjust_Delta to an existing parking point offset SSP_Offset_Adjust as a parking point offset used by the stop in the next learning period. If n stop results of a certain learning period do not satisfy the determination condition for the train stop statistical stationary, then it is necessary to clear the existing parking point offset SSP_Offset_Adjust, and after the n stop results which satisfy the acceptable stop statistical condition are taken as the first learning period, the parking point offset SSP_Offset_Adjust is recalculated, and then statistical evaluation is performed on the new round of stop results.

In addition, with respect to the cases of S41 and S42, a first-type exit learning mechanism and a second-type exit learning mechanism are designed respectively. The first-type exit learning mechanism is: when the number of restarting a learning process due to the abrupt change of the train stop characteristic in a single instant evaluation of the train exceeds a preset abrupt change number threshold, then the learning process is not restarted subsequently, and the present method is no longer used to control parking. The second-type exit learning mechanism is: when the number of restarting a learning process due to the reason that the train stop does not satisfy the statistical stationary characteristic during statistical train evaluation exceeds a preset non-stationary number threshold, then the learning process is not restarted subsequently, and the present method is no longer used to control parking. The first-type exit learning mechanism and the second-type exit learning mechanism operate at the same time; when one type of exit learning mechanism is triggered first, so that a learning process is no longer restarted and the method is no longer used, the other type of exit learning mechanism also stops operating.

While the present invention has been described in detail with reference to the preferred embodiments, it should be understood that the above description should not be taken as limiting the invention. Various modifications and alternatives to the present invention will become apparent to those skilled in the art upon reading the foregoing disclosure. Accordingly, the protection scope of the present invention shall be limited by the appended claims.

1. An adaptively adjusted and accurate parking control method for an ATO system, comprising the following steps:
S1, monitoring a speed tracking performance of a train during each stop process, and determining whether each stop process of the train satisfies an acceptable stop statistical condition;
S2, updating the result of a stop process satisfying the acceptable stop statistical condition to a stop array queue, and using n stops as a learning period to calculate a statistical feature of every n stop results;
S3, adaptively calculating a parking point offset according to the calculated statistical feature of every n stop results in S2; and
S4, evaluating, on the basis of the above steps, the every stop result of the train and the stop results within each learning period, and if a preset threshold is exceeded, then clearing the existing parking point offset and restarting a new round of learning process.

2. The adaptively adjusted and accurate parking control method for an ATO system according to claim 1, wherein the acceptable stop statistical condition comprises: good speed tracking performance in an electric braking process during the train stop stage, no interference during the train stop stage, and a train stop accuracy satisfying a preset threshold.

3. The adaptively adjusted and accurate parking control method for an ATO system according to claim 2, wherein a determination standard of the good speed tracking performance in an electric braking process during the train stop stage is: a reference speed in the electric braking process of the train is set as a target speed: a difference between the target speed and an actual train speed is defined as a speed deviation; and if the speed deviation satisfies a preset threshold, or if the speed deviation exceeds a preset threshold but the speed tracking process converges, then the speed tracking performance in the electric braking process during the train stop stage is considered to be good.

4. The adaptively adjusted and accurate parking control method for an ATO system according to claim 2, wherein interference factors during the train stop stage comprise: non-master core control, non-ATO train control, and platform stopping by taking a non-parking point as the strongest constraint.

5. The adaptively adjusted and accurate parking control method for an ATO system according to claim 1, wherein the acceptable stop statistic condition is also applied to a train real-time stop process; and when a certain train real-time stop process does not satisfy the acceptable stop statistic condition, the stop does not use the method.

6. The adaptively adjusted and accurate parking control method for an ATO system according to claim 1, wherein the stop array queue is SSP_Accuracy_Array, and the statistical feature of every n stop results comprises a median offset Offset_Median, a mean offset Offset_Mean and a standard deviation offset Offset_Std.

7. The adaptively adjusted and accurate parking control method for an ATO system according to claim 6, wherein a calculation formula of the parking point offset SSP_Offset_Adjust is:
SSP_Offset_Adjust+=Adjust_Delta;
wherein, Adjust_Delta is a correction increment of a learning period, the sign+=represents an accumulation operation, and the above formula represents accumulating the correction increment Adjust_Delta of the current learning period on the basis of the last learning period.

8. The adaptively adjusted and accurate parking control method for an ATO system according to claim 7, wherein a calculation formula of the correction increment Adjust_Delta is as follows:
$$Adjust\_Delta = \{ \begin{matrix}QUICK\_STEP \times SIGN ( \cdot ) , & In QUICK\_REGION \\ FINE\_STEP \times SIGN ( \cdot ) , & In FINE\_REGION \\ 0 , & Otherwise\end{matrix}$$
wherein QUICK_REGION is a preset fast adjustment region, and QUICK_STEP represents a fast adjustment step length adopted when Offset_Median is in the fast adjustment region QUICK_REGION: FINE_REGION is a preset fine adjustment region, and FINE_STEP represents a fine adjustment step length adopted when Offset_Median is within the fine adjustment region FINE_REGION: SIGN (⋅) is a sign operation function which returns ±1 according to the positivity and negativity of Offset_Median.

9. The adaptively adjusted and accurate parking control method for an ATO system according to claim 7, wherein the parking point offset SSP_Offset_Adjust is constrained with limit values: an upper adjustment limit value and a lower adjustment limit value are set: when a parking point offset SSP_Offset_Adjust acquired after a learning period is greater than the upper adjustment limit value, then the upper adjustment limit value is taken as the parking point offset of the train in the next learning period; and when the parking point offset SSP_Offset_Adjust acquired after a learning period is less than the lower adjustment limit value, then the lower adjustment limit value is taken as the parking point offset of the train in the next learning period.

10. The adaptively adjusted and accurate parking control method for an ATO system according to claim 7, wherein step S4 comprises the following two cases:
S41, instantly evaluating a single stop result of the train, and if a train stop characteristic abruptly changes, then clearing the existing parking point offset SSP_Offset_Adjust, and immediately restarting a new round of learning process; and
S42, statistically evaluating the stop results of the train in each learning period, and if the n stop results of the train in the learning period do not satisfy a statistical stationary characteristic, then clearing the existing parking point offset SSP_Offset_Adjust, and restarting a new round of learning process.

11. The adaptively adjusted and accurate parking control method for an ATO system according to claim 10, wherein the definition for abrupt changes of train stop characteristic is: a certain stop accuracy of a train having an under-docking characteristic exceeds a preset allowable over-docking distance, or a certain stop accuracy of a train having an over-docking characteristic exceeds a preset allowable under-docking distance.

12. The adaptively adjusted and accurate parking control method for an ATO system according to claim 11, wherein the train having an under-docking characteristic means that the existing parking point offset SSP_Offset_Adjust is greater than zero; and the train having an over-docking characteristic means that the existing parking point offset SSP_Offset_Adjust is less than zero.

13. The adaptively adjusted and accurate parking control method for an ATO system according to claim 10, wherein the conditions for determining whether the train stop satisfies the statistical stationary characteristic are as follows: a difference between the mean offset Offset_Mean and the median offset Offset_Median does not exceed a preset deviation threshold, and the standard deviation offset Offset_Std does not exceed a preset convergence trend threshold.

14. The adaptively adjusted and accurate parking control method for an ATO system according to claim 10, wherein when the number of restarting a learning process due to the abrupt change of the train stop characteristic in a single instant evaluation of the train exceeds a preset abrupt change number threshold, then the learning process is not restarted subsequently, and the present method is no longer used to control parking; and when the number of restarting a learning process due to the reason that the train stop does not satisfy the statistical stationary characteristic during statistical train evaluation exceeds a preset non-stationary number threshold, then the learning process is not restarted subsequently, and the present method is no longer used to control parking.
